(19) United States
(12) Patent Application Publication
(10) Pub. No.: US 2018/0112555 A1
(43) Pub. Date: Apr. 26, 2018

(54) DAMPED GUIDE VANE BEARING ARRANGEMENT

(71) Applicant: MTU Aero Engines AG, Muenchen (DE)

(72) Inventor: Werner Humhauser, Moosburg (DE)

(21) Appl. No.: 15/793,012

(22) Filed: Oct. 25, 2017

(30) Foreign Application Priority Data
Oct. 26, 2016 (EP) 16195673.5

(51) Int. Cl. F01D 25/16; F01D 9/04

(52) U.S. Cl. CPC F01D 25/164; F02C 7/06; F01D 9/041; F01D 9/042

(57) ABSTRACT

An annular guide vane assembly includes an inner ring and a plurality of guide vanes. A radially inner end of each of the guide vanes is inserted into a respective one of the bearing members, and the inner ring has (at its radially outer surface) a receiving channel extending in the circumferential direction for the bearing members. The annular guide vane assembly further includes at least one damping element disposed in the receiving channel between the bearing members and the inner ring. A method provides that a damping element is inserted into a receiving channel of an inner ring segment, and a plurality of bearing elements are strung together within the receiving channel of the inner ring segment. After that, the inner ring segment and at least one additional inner ring segment are connected together to form an inner ring.

This claims the benefit of European Patent Application EP 16195673.5, filed Oct. 26, 2016 and hereby incorporated by reference herein.

The present invention relates to an annular guide vane assembly for a turbomachine, a turbomachine, and a method for assembling an annular guide vane assembly.

### BACKGROUND

Turbomachines, such as aircraft engines and stationary gas turbines, often have at least one annular guide vane assembly to establish optimum operating conditions.

The annular guide vane assembly includes an inner ring and a plurality of guide vanes, each of which has one end disposed on the inner ring and extends radially outwardly therefrom. As used herein and unless otherwise stated, the terms “radial,” “axial,” and “in the circumferential direction” always refer to a central geometric axis of the annular guide vane assembly and of the inner ring, which is not always specifically stated for better readability. When such terms relate to individual components of the annular guide vane assembly, they are to be understood to refer to the intended orientation of the respective component in the annular guide vane assembly.

An annular guide vane assembly may, in particular, be configured to be adjustable. In this case, the guide vanes are each rotatable about a respective intended axis of rotation, which generally coincides with the longitudinal axis of the respective guide vane and extends substantially radially.

The rotation may be caused by outer actuating components on the guide vanes, in particular by actuating trunnions which are inserted, or to be inserted, in corresponding receiving holes of the casing and which are then capable of cooperating with a corresponding actuating device on the outer casing.

In known annular guide vane assemblies, the guide vanes are stabilized at their inner ends by trunnions which extend radially inwardly from respective vane disks and may be supported in bushings of the inner ring.

EP 2 696 041 A1 describes an annular, variable guide vane assembly where the guide vanes are each supported in an individual bearing member and where the inner ring is composed of two half-rings, which are pushed onto the bearing members in the circumferential direction during assembly. The bearing members may each have cuboid main body having a corresponding bearing bore. Such a guide vane assembly offers the advantages of easy assembly and low leakage.

### SUMMARY OF THE INVENTION

It is an object of the present invention to provide a technique that permits these advantages to be maintained, while at the same time improving durability and leakage prevention.

This object is achieved by an annular guide vane assembly for a turbomachine, a turbomachine, and a method. Advantageous embodiments are disclosed in the dependent claims, the description, and the FIGURES.

An inventive annular guide vane assembly for a turbomachine includes an inner ring having a receiving channel extending in the circumferential direction, as well as a plurality of guide vanes and a plurality of bearing members which are disposed in the receiving channel of the inner ring and into each of which is inserted a radially inner end (e.g., a bearing element such as, in particular, a trunnion) of the guide vanes. The annular guide vane assembly further includes at least one damping element disposed in the receiving channel between the bearing members and the inner ring.

The annular guide vane assembly may be intended for a compressor stage or a turbine stage of the turbomachine.

The radially inner ends of the guide vanes may each be inserted in a separate bearing member associated therewith and/or the annular guide vane assembly may include guide vanes whose radially inner ends are inserted in a common bearing member (e.g., in groups of two, three or more guide vanes). In particular, the annular guide vane assembly may include a number of bearing members equal to or less than the number of guide vanes.

The at least one damping element serves to damp relative movements between the bearing members and the inner ring and between the guide vanes and the inner ring. In this way, it is possible, in particular, to reduce oscillation amplitudes of the guide vanes, which may be caused by the aforementioned relative movements. The aforementioned relative movements or oscillations result in particular from vibrations during operation of the turbomachine and may lead to wear and impairment of the efficiency of the turbomachine. Therefore, using the at least one damping element, it is possible, in particular, to counteract material fatigue of the guide vanes due to loading over a long period of time.

Preferably, the inner ring is composed of two or more inner ring segments. Such an inner ring segment is preferably provided at at least one of its circumferential ends with an entry opening to the receiving channel, through which a plurality of bearing members can be successively strung onto the inner ring segment (for example by pushing or pulling the inner ring segment onto the bearing members).

A method according to the present invention serves for assembling an annular guide vane assembly, such as an annular guide vane assembly according to any of the embodiments disclosed herein. In particular, the various individual components and features may exhibit the specific properties mentioned herein. The method includes inserting at least one damping element into a receiving channel of an inner ring segment, which receiving channel extends in the circumferential direction (relative to a central axis of the annular guide vane assembly or of the inner ring segment). The method further includes stringing the plurality of bearing elements, which each have a radially inner end of a guide vane inserted therein, onto the inner ring segment and, more specifically, into the receiving channel thereof, which has at least one damping element inserted therein. After that, the inner ring segment and at least one additional inner ring segment are assembled together to form an inner ring.

During stringing, the guide vanes are each preferably fixed in position at their radially outer ends on a casing, for example, by an actuating trunnion of the respective guide vane inserted in a receiving hole in the casing. The stringing process may then include pushing or pulling the inner ring segment over the radially inwardly projecting ends of the guide vanes and their respective bearing members.

Such a method makes assembly particularly easy and provides an annular guide vane assembly that is advantageous in terms of structural mechanics, and in which relative movements of the guide vanes and the inner ring are minimized. This makes it possible to minimize wear and material fatigue.

In accordance with a preferred embodiment, an annular guide vane assembly according to the present invention has a seal for sealing a radial clearance between the inner ring and an opposite rotor portion. For this purpose, the inner ring may function as a seal carrier. The seal (which may be, for example, an abradable liner, in particular a honeycomb seal, or a brush or lip seal) may be attached to or monolithically formed on, or (in a method according to the present invention) may become formed on, a surface of the inner ring located opposite the receiving channel.

The at least one damping element may be disposed radially and/or axially between the bearing members and the inner ring. In an advantageous embodiment, the at least one damping element is completely or partially disposed further radially inward than the bearing members, for example in a slot provided at the bottom of the receiving channel. The damping element is preferably designed to be flexible and may, for example, take the form of a spring element whose spring force urges the inner ring and at least one of the bearing elements apart at the position of the spring element (and thus against each other at a different point). Such an annular guide vane assembly is particularly easy to assemble because the bearing members can be inserted while the spring element is loaded, and when the spring element is unloaded, it presses the bearing members against a region of the inner ring, so that an existing gap can be sealed.

In an advantageous embodiment of the present invention, the bearing elements are connected to the inner ring with an interlocking fit, preferably in the axial and/or radial direction. In particular, a side wall of the receiving channel (i.e., one which bounds the receiving channel in the axial direction) may include at least one circumferentially extending groove into which engages a corresponding projection of at least one of the bearing members.

In an advantageous embodiment, the at least one damping element and/or the receiving channel have/has a respective fixing means adapted to fix the damping element in place within the receiving channel prior to inserting the bearing members. This simplifies the assembly of the inner ring. Such a fixing means may be, for example, a groove in a side wall of the receiving channel (i.e., one which bounds the receiving channel in the axial direction) into which an axial edge portion of the damping element is at least partially inserted. Alternatively, the damping element may be attached to at least one of the bearing members.

In an advantageous embodiment, the at least one damping element is in the form of a ring or a ring segment extending within the receiving channel in the circumferential direction. Such a ring segment may extend over an angle of, for example, 180°, 120° or 90° about the (central) axis. The damping element may include, for example, a strip of flexible material whose ends are connected together or each connected to a respective end of another strip (preferably after insertion into the receiving channel). In accordance with one specific, exemplary embodiment, the damping element includes a strip of sheet metal that is curved in the radial direction.

The inner ring and/or the at least one damping element may have a plurality of irregularities and/or a rough surface in a region of contact therebetween. This makes it possible to provide a particularly good engagement surface for the damping element, and thus to achieve a particularly good damping effect, making it possible in particular to minimize relative movement of the damping element and the inner ring.

Similarly (alternatively or additionally), the at least one damping element and/or at least one of the bearing members may have a plurality of irregularities and/or a rough surface in a region of contact (between the damping element and the bearing member). This makes it possible to minimize relative movement of the damping element and the bearing member.

A turbomachine according to the present invention includes at least one compressor and/or turbine stage including at least one inventive annular guide vane assembly according to any of the embodiments disclosed herein. The turbomachine may in particular be an aircraft engine.

### BRIEF DESCRIPTION OF THE DRAWINGS

Preferred exemplary embodiments of the present invention will be described in greater detail below with reference to a drawing. It is understood that individual elements and components may be combined in other ways than those described.

FIG. 1 is a schematic perspective view of a portion of an exemplary annular, variable guide vane assembly according to the present invention.

### DETAILED DESCRIPTION

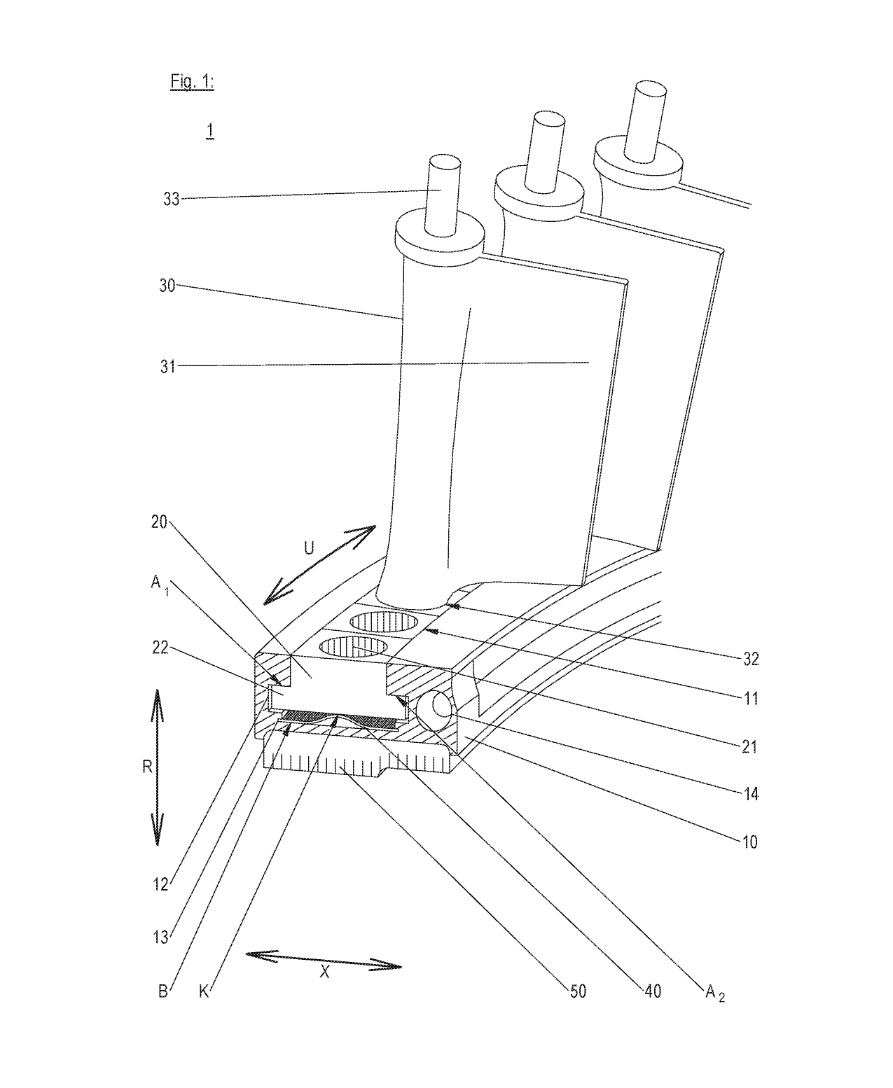

FIG. 1 shows a portion of an annular, variable vane assembly 1 according to an embodiment of the present invention. The annular guide vane assembly includes an inner ring 10 composed of a plurality (e.g., two) inner ring segments. The FIGURE shows only a portion of inner ring 10, namely an end of an inner ring segment which has a bore 14 for connection with an end of another ring segment (by means of a pin (not shown) to be passed therethrough). At the end shown, the inner ring segment has an entry opening to a receiving channel 11 extending in circumferential direction U for receiving bearing members 20. During assembly, the bearing members can be successively strung onto the inner ring segment through this entry opening. In the exemplary embodiment shown in the FIGURE, the stringing process has already been completed, and the bearing members 20 are lined up within receiving channel 11 and adjoin one another at radially extending planar surfaces.

Annular guide vane assembly 1 further includes a plurality of guide vanes 30, each of which is inserted with its radially inner end 32 (which preferably includes a bearing element, such as a trunnion) into an associated bearing member 20 (i.e., into a bushing 21 disposed therein). The respective end of the guide vanes and/or a surface of the bearing members within the bore may be coated to reduce friction and/or wear. In the FIGURE, the two forwardmost bearing members are shown without anything mounted to it; i.e., without having an end of a guide vane inserted therein.

The guide vanes each have an airfoil 31 and can each be rotated via an actuating trunnion 33, which is adapted to be inserted into a respective receiving hole in a casing (not shown).

In the exemplary embodiment shown in the FIGURE, bearing member 20 and inner ring 10 are connected together with an interlocking fit; in the present case, more specifically, in both axial direction X and radial direction R. To this end, each of the side walls of receiving channel 11 has a groove 12 in which is inserted corresponding projection 22 of bearing members 20.

Annular guide vane assembly 1 further includes a damping element 40, which is disposed between inner ring 10 and bearing members 20 at a (radially inward) bottom of receiving channel 11. The damping element may be configured, for example, as a spring element (e.g., in the form of a sheet-metal element) whose spring force urges bearing members 20 radially outwardly. In the example shown, the damping element takes the form of a strip that is curved radially inwardly in its central flexible region, and because of this, the bearing members are pressed with their projections 22 against a corresponding region A₁, A₂ of inner ring 10, which increases the friction between the bearing members and the inner ring in these regions (thereby damping relative movement between the inner ring and the guide vanes).

Receiving channel 11 is provided at each of its sides with a groove 13 (looking in the circumferential direction) as a fixing means for damping element 40, into each of which is inserted (e.g., pushed or pulled) an edge portion of damping element 40. This facilitates handling during assembly because the damping element cannot fall out of receiving channel 11 as long as bearing members 20 have not yet been inserted.

In a region of contact B between inner ring 10 and damping element 40, the surface of the inner ring (within the receiving channel) and/or the surface of damping element 40 may preferably have a plurality of irregularities and/or be rough. This can reduce relative movement between inner ring 10 and damping element 40.

Alternatively or additionally, in a region of contact K between damping element 40 and bearing members 20, the surface of the damping element and/or the surface of at least one of the bearing members 20 may preferably have a plurality of irregularities and/or be rough. This can reduce relative movement between damping element 40 and bearing members 20.

In the exemplary embodiment shown, annular guide vane assembly 1 includes a seal 50 (here in the form of an abradable liner) for sealing a radial clearance between the inner ring and an opposite rotor portion. For this purpose, inner ring 10 functions as a seal carrier.

An annular guide vane assembly 1 according to the present invention includes an inner ring 10 and a plurality of guide vanes 30. A radially inner end 32 of each of the guide vanes is inserted into a respective one of the bearing members 20, and the inner ring has (at its radially outer surface) a receiving channel 11 extending in circumferential direction U for receiving the bearing members. The annular guide vane assembly further includes at least one damping element 40 disposed in receiving channel 11 between bearing members 20 and inner ring 10.

A method according to the present invention serves for assembling an annular guide vane assembly. In the process, a damping element 40 is inserted into a receiving channel 11 of an inner ring segment, and a plurality of bearing members 20 are strung together within the receiving channel of the inner ring segment. After that, the inner ring segment and at least one additional inner ring segment are connected together to form an inner ring.

### REFERENCE NUMERALS

1 annular guide vane assembly
10 inner ring
11 receiving channel
12 groove for a projection 22 on the bearing member
13 groove for an edge portion of damping element 40
14 bore for connecting ring segments
20 bearing member
21 bore
22 projection
30 guide vane
31 airfoil
32 radially inner end of the guide vane
33 actuating trunnion
40 damping element
50 seal
A₁, A₂ region of the inner ring
B region of contact between the inner ring and the damping element
K region of contact between the damping element and bearing members
R radial direction
U circumferential direction
X axial direction

1-10. (canceled)

11: An annular guide vane assembly for a turbomachine, comprising:
an inner ring having at a radially outer surface a receiving channel extending in the circumferential direction;
a plurality of bearing members disposed in the receiving channel of the inner ring;
a plurality of guide vanes, each of the guide vanes being inserted via a radially inner end into a respective one of the bearing members; and
a damping element disposed in the receiving channel between the bearing members and the inner ring.

12: The annular guide vane assembly as recited in claim 11 wherein the bearing elements are connected to the inner ring with an interlocking fit.

13: The annular guide vane assembly as recited in claim 11 wherein the damping element is a spring with a spring force urging the inner ring and at least one of the bearing elements against each other in at least one region.

14: The annular guide vane assembly as recited in claim 11 wherein the damping element is attached to at least one of the bearing members.

15: The annular guide vane assembly as recited in claim 11 wherein the damping element is at least partially made of metal.

16: The annular guide vane assembly as recited in claim 11 wherein the damping element is a ring or a ring segment extending within the receiving channel extending in the circumferential direction.

17: The annular guide vane assembly as recited in claim 11 wherein the inner ring has a plurality of irregularities or a rough surface in a region of contact with the damping element.

18: The annular guide vane assembly as recited in claim 11 wherein the damping element has a plurality of irregularities or a rough surface in a region of contact with the inner ring.

19: A turbomachine comprising the annular guide vane assembly as recited in claim 11.

20: A method for assembling an annular guide vane assembly, comprising:
inserting at least one damping element into a receiving channel of an inner ring segment, the receiving channel extending in the circumferential direction;
stringing together the plurality of bearing elements, each of the bearing elements having a radially inner end of a guide vane inserted therein, within the receiving channel of the inner ring segment, the receiving channel having the at least one damping element inserted therein; and subsequently
connecting the inner ring segment and at least one additional inner ring segment together to form an inner ring.
